(19) United States
(12) Patent Application Publication
(10) Pub. No.: US 2008/0065457 A1
(43) Pub. Date: Mar. 13, 2008

(54) Equipment Provider and Purchaser Program

(75) Inventors: Douglas Roger Hundt, Pella, IA (US); Michael Charles Byram, Pella, IA (US); Christopher Lee Nichols, Knoxville, IA (US); Mark Armstrong Rieckhoff, Oskaloosa, IA (US); Kristi Rane Roose, Pella, IA (US)

Correspondence Address: MERCHANT & GOULD PC, P.O. BOX 2903, MINNEAPOLIS, MN, 55402-0903, US

(73) Assignee: Vermeer Manufacturing Company, Pella, IA (US)

(21) Appl. No.: 11/467,765

(22) Filed: Aug. 28, 2006

(51) Int. Cl. G06F 15/02

(52) U.S. Cl. 705/9

(57) ABSTRACT

Systems and methods for an equipment manufacturer to form a program with an equipment purchaser. The method can include enrolling the equipment purchaser in the program, having historical losses and potential risks for the equipment purchaser assessed, and facilitating an insurance package for the equipment purchaser if the equipment purchaser qualifies based on the assessment of the historical losses. The method also includes having workforce needs for the equipment purchaser assessed, and facilitating recruitment, training, and hiring of workers to meet the workforce needs of the equipment purchaser. The method further includes having service needs of the equipment purchaser assessed, facilitating periodic service for the equipment purchaser's equipment, and facilitating replacement or substitution if the equipment fails.

### BACKGROUND

The profitability and ultimate success of a company is dependent upon a variety of factors. For example, in the tree care maintenance and removal industry, the ability to recruit, train, and retain workers, as well as to service and maintain equipment, can be keys to the success or failure of a company. The impact of these and similar other factors on the company's success can vary depending on the company's size. For example, the average company in the tree care industry has 15 employees. The relative small size of these companies makes it difficult for the companies to devote internal resources to adequately address these factors. Thus, many companies may be forced to seek out more costly alternatives.

For example, tree care companies are dependent on expensive equipment that is often used on a daily basis for the maintenance and removal of trees. The costs associated with maintaining such equipment can be significant, but the impact of downtime due to equipment failure can be costly and lead to lost productivity.

Further, training in an industry such as tree care maintenance is important due to the challenges associated with the working environment. However, there can be a significant variation in the amount of training provided to workers in the industry. Inadequate training practices can contribute toward increased job-related accidents and injuries. In general, these and other factors have resulted in the insurance industry applying a relatively high cost classification to the tree care industry.

In addition, the workforce in an industry such as the tree care industry exhibits a large turnover rate. Some estimates for the tree care industry show an annual turnover rate of up to 25 percent for workers. This can lead to shortages in workers, particularly those workers with the proper skill sets for the job. The problem is exacerbated by the fact that the tree care industry is currently experiencing rapid growth due to such factors as urbanization, imported diseases and pests, utility line maintenance, and storm and natural disaster damage. This growth leads to further demand for workers in a market that is already short in supply.

Therefore, there arises a need in the art for systems and methods for providing assistance to companies that will form the foundation for increased or improved profitability and/or success for the companies. Aspects of the following disclosure address this need and minimize several of the shortcomings noted above.

### SUMMARY

According to one aspect, the present disclosure relates to a method for an equipment manufacturer to form a program with an equipment purchaser, the method including: enrolling the equipment purchaser in the program; facilitating an insurance package for the equipment purchaser; facilitating recruitment, training, and hiring of workers to meet the workforce needs of the equipment purchaser; having service needs of the equipment purchaser assessed; facilitating periodic service for the equipment purchaser's equipment; and facilitating replacement or substitution if the equipment fails.

According to another aspect, the present disclosure relates to a method for forming a program with a tree care equipment manufacturer and an equipment purchaser, the method including: enrolling the equipment purchaser if the equipment purchaser qualifies for the program; providing an insurance package for the equipment purchaser; recruiting, training, and placing workers to meet the workforce needs of the equipment purchaser; assessing service needs of the equipment purchaser; providing periodic service for the equipment purchaser's equipment; and providing replacement or substitution if the equipment fails.

According to yet another aspect, the present disclosure relates to a system for forming a program with an equipment provider and an equipment purchaser. The system includes an insurance service including an insurance package that is provided for the equipment purchaser. The system also includes a workforce service including recruitment and training of workers for the equipment purchaser, and a maintenance service including periodic servicing of the equipment purchaser's equipment, and, upon failure of the equipment, loaner equipment for the equipment purchaser if repairs to the failed equipment cannot be made in a specified period of time.

### DESCRIPTION OF THE DRAWINGS

Reference will now be made to the accompanying drawings, which are not necessarily drawn to scale.

FIG. 1 shows an example system diagram of an industry including a program with an equipment provider and an equipment purchaser.

FIG. 2 shows another system diagram of the industry of FIG. 1.

FIG. 3 shows an example system diagram including a communications scheme between an equipment provider and an equipment purchaser.

FIG. 4 shows an example computer system of the system of FIG. 3.

FIG. 5 shows an example method for qualifying an equipment purchaser for enrollment in a program with an equipment provider.

FIG. 6 shows an example method for enrolling the equipment purchaser in the program with the equipment provider.

FIG. 7 shows an example method for implementing an insurance service as part of the program with the equipment provider and the equipment purchaser.

FIG. 8 shows an example method for implementing a workforce service as part of the program with the equipment provider and the equipment purchaser.

FIG. 9 shows an example method for implementing a maintenance service as part of the program with the equipment provider and the equipment purchaser.

### DETAILED DESCRIPTION

Example embodiments will now be described more fully hereinafter with reference to the accompanying drawings. These embodiments are provided so that this disclosure will be thorough and complete. Like numbers refer to like elements throughout.

Generally, the present disclosure relates to a program including an equipment provider and purchasers of the equipment, referred to herein as equipment purchasers. In example embodiments, an equipment provider is an entity that manufacturers and/or sells equipment to an equipment purchaser. The sale to the equipment purchasers can be made directly from the equipment provider, or through an intermediary such as a dealer or other representative.

For example, in the tree care maintenance and removal industry, an equipment provider is a manufacturer of tree care maintenance equipment such as, without limitation, brush chippers, stump cutters, tree spades, and tub and horizontal grinders. The equipment provider establishes relationships with equipment purchasers that purchase such equipment and provide tree care maintenance services to end customers.

In example embodiments, the program formed with the equipment provider and the equipment purchasers addresses a plurality of factors that can increase the productivity of the equipment purchasers and provides access to goods and services at preferred rates. Examples of the factors addressed by the program include, without limitation, insurance, workforce, and service needs. Other factors can also be addressed.

By utilizing the benefits associated with the program, both the equipment provider and purchasers realize benefits. For example, for the equipment provider, the program can enhance relationships with and loyalty from equipment purchasers, which ultimately leads to increased equipment sales revenue. For the equipment purchasers in the tree care industry, the program can lead to increased productivity in view of the factors addressed by the program. The features of the example program with the equipment provider and equipment purchasers are further illustrated in the example embodiments described below.

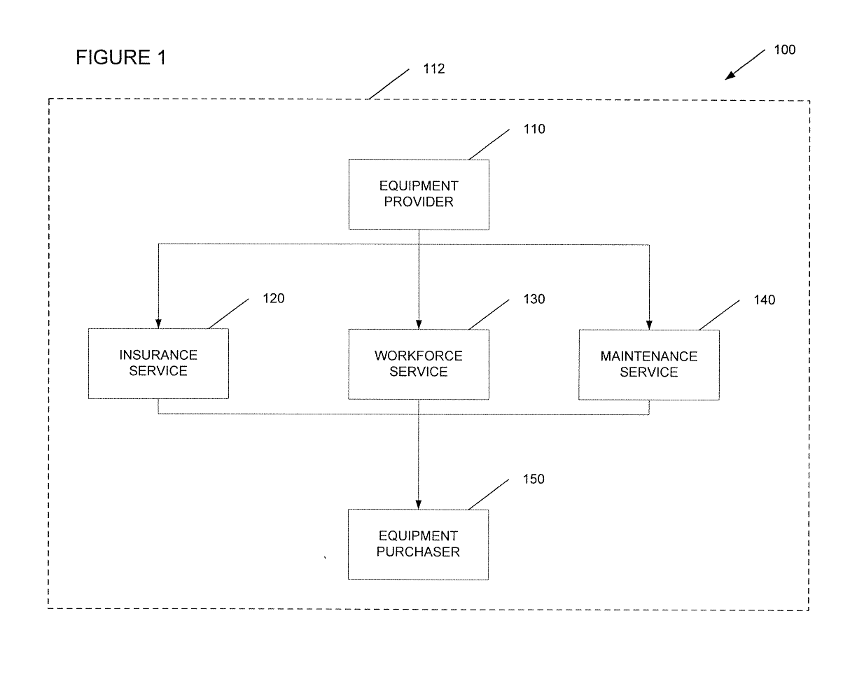

Referring now to FIG. 1, an example industry 100 is shown. In the illustrated example, industry 100 is the tree care maintenance and removal industry, although other industries can also be used. Industry 100 includes an equipment provider 110 and an equipment purchaser 150.

In the example shown, equipment provider 110 is a manufacturer of tree care equipment such as, without limitation, Vermeer Manufacturing Company of Pella, Iowa. Equipment provider 110 manufactures tree equipment such as, for example, chippers, grinders, and stump cutters.

Equipment purchaser 150 is a company in tree care industry 100 that purchases equipment from equipment provider 110, a representative of equipment provider 110 (e.g., a dealer), or another equipment provider in tree care industry 100. Equipment purchaser 150 uses the purchased equipment to provide tree care maintenance and removal services to end customers.

In the example shown, equipment provider 110 and equipment purchaser 150 form a program 112. Program 112 can include one or more services tailored to address a plurality of factors associated with industry 100. Examples of these services include an insurance service 120, a workforce service 130, and a maintenance service 140.

Insurance service 120 is used to address insurance needs in industry 100. For example, insurance service 120 is configured to assess the historic losses and potential risks for equipment provider 150 and provide risk awareness and loss control training in those areas that are highlighted in the assessment. Insurance service 120 is configured to assist equipment purchaser 150 to reduce the frequency and severity of incidents and financial costs per incidents, thereby creating the potential for reduced premiums or increased dividends associated with insurance coverage depending on historic loss assessments, or provide loss management training if the historic assessment indicates areas of weakness. More specifics related to insurance service 120 are described below in reference to method 600.

Workforce service 130 is used to address workforce and training needs in industry 100. For example, workforce service 130 is tailored to address the specific tree care worker needs of equipment purchaser 150. Workforce service 130 can include recruitment and training of workers based on the assessment of need, and the ultimate hiring of the workers by equipment purchaser 150 after training. More specifics related to workforce service 130 are described below in reference to method 700.

Maintenance service 140 is used to address maintenance and repair needs for equipment in industry 100. For example, maintenance service 140 is tailored to define and address the service and repair needs for the equipment of equipment purchaser 150. This can include periodic service, as well as repairs. In some embodiments, repair time is guaranteed, or loaner equipment is provided if the repair cannot be made within the guaranteed period, so that costs associated with downtime are minimized. More specifics related to maintenance service 140 are described below in reference to method 800.

For simplicity purposes, only a single equipment purchaser 150 is shown in example industry 100. In reality, a plurality of equipment purchasers 150 operate within industry 100. For example, a plurality of equipment purchasers 150 can purchase equipment and participate in the program with equipment provider 110.

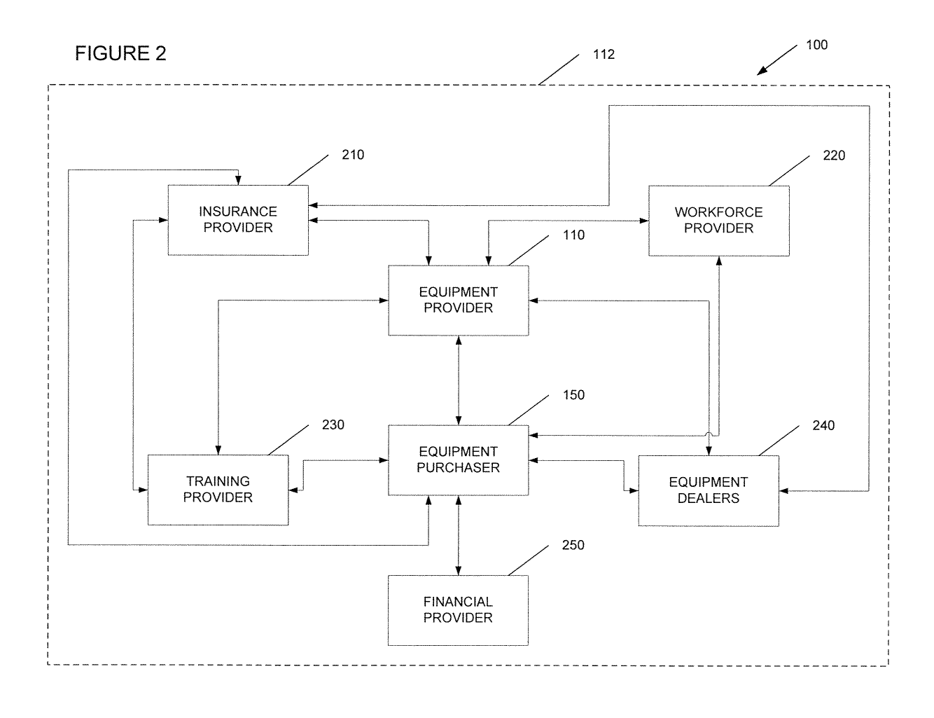

Referring now to FIG. 2, example tree care industry 100 is again shown, including equipment provider 110 and equipment purchaser 150 that have formed program 112. Also shown is a plurality of entities that can assist in implementing example services 120, 130, 140 associated with program 112. For example, as described further below, an insurance provider 210 and a training provider 230 can assist in facilitating insurance service 120 of program 112. Likewise, a workforce provider 220 and training provider 230 can assist in facilitating workforce service 130 of program 112. Equipment dealers 240 can assist in facilitating maintenance service 140 of program 112. Finally, a financial provider 250 can assist in the financing of membership in program 112.

In example embodiments, insurance provider 210 is an insurance broker and/or underwriter that writes insurance for companies that provide tree care maintenance and removal services within tree care industry 100. In one embodiment, insurance provider 210 is a national insurance broker, such as Acordia, Inc. of Chicago, Ill.

In example embodiments, workforce provider 220 is a temporary and/or permanent placement employment services company that recruits workers for tree care industry 100. In one embodiment, workforce provider 220 is a national employment services company, such as Manpower Inc. of Milwaukee, Wis.

In example embodiments, training provider 230 is a provider that specializes in training workers in tree care industry 100. In one embodiment, training provider 230 is a nationally-recognized provider, such as ArborMaster Training, Inc. of Willington, Conn.

In example embodiments, equipment dealers 240 are local dealers located throughout the specified territory (e.g., United States) that interface directly with equipment purchasers for purchasing and servicing equipment. In one embodiment, equipment dealers 240 are affiliated with equipment provider 110.

In example embodiments, financial provider 250 is a financial institution that issues credit cards. In some embodiments, the credit cards are affinity cards that can be branded according to equipment provider 110 and can be used to accumulate “points” or “credits” for the purchase of additional equipment from equipment provider 110. In one embodiment, financial provider 250 is a financial services provider, such as GE Consumer Finance of Stamford, Conn.

In example embodiments, equipment provider 110 negotiates and enters into agreements with providers 210, 220, 230, 240, 250 so that providers are associated with program 112. As part of this association, providers 210, 220, 230, 240, 250 provide preferred rates on goods and services that are offered to equipment purchasers 150 that enter program 112, as described below.

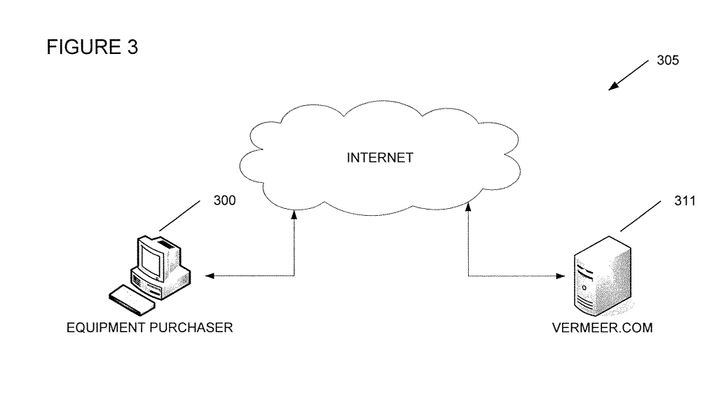

Referring now to FIG. 3, an example system 305 is shown for establishing program 112 with equipment provider 110 and equipment purchaser 150. In example system 305, equipment purchaser 150 uses a computer system 300 to contact equipment provider 110 at a web site 311 (e.g., “www.vermeer.com”) through the Internet to request enrollment in program 112. For example, in one embodiment, equipment purchaser 150 uses computer system 300 to visit web site 311 of equipment provider 110 to answer a plurality of questions, described further below, associated with qualifying for and enrolling in program 112. Equipment provider 110 uses the answers provided on web site 311 to determine the eligibility of equipment purchaser 150 for program 112. Equipment provider 110 can likewise communicate back to equipment purchaser 150 through the Internet regarding enrollment in program 112.

In example embodiments, the initial enrollment and many aspects of program 112 can be conducted online using system 305. For example, equipment purchaser 150 can enroll in program 112 using system 305, as well as receive information about services 120, 130, 140 and communicate with other entities such as providers 210, 220, 230, 240 using system 305. In alternative embodiments, other forms of communication can be used. For example, in alternative embodiments, equipment purchaser 150 can enroll and conduct business related to program 112 using a telephone (e.g., a toll-free number) or by mail. Other configurations are possible.

In the example shown, web site 311 is hosted on one or more servers that are accessible through a network, such as the Internet. Each server hosting web site 311 includes one or more processing units, memory, and mass storage. The server can be programmed to include a web server to host web site 311 and to allow interaction with one or more client computers, such as computer system 300. In example embodiments, the server is programmed to facilitate providing information to the equipment purchase, enrolling the equipment purchaser in program 112, and implementing the services associated with program 112.

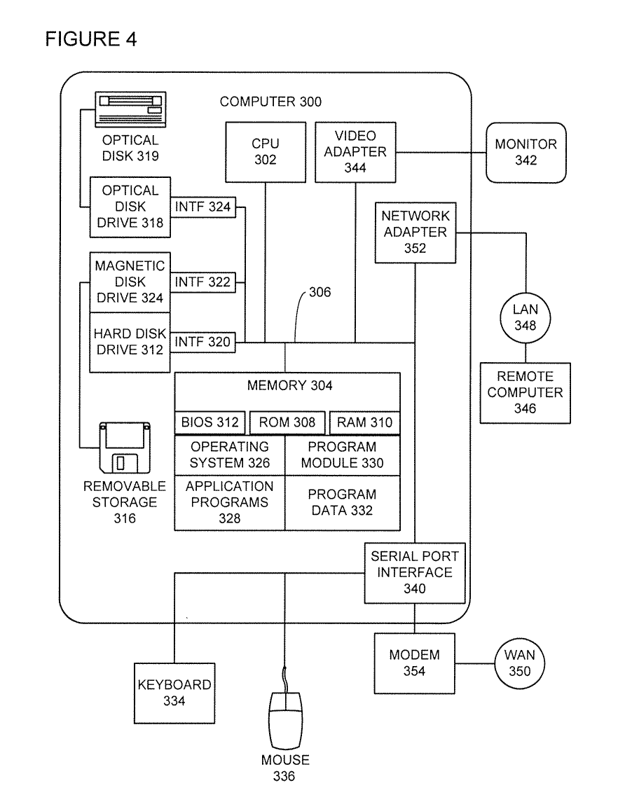

Referring now to FIG. 4, computer system 300 is shown in greater detail. Computer system 300 can take a variety of forms such as, for example, a desktop computer, a laptop computer, and a hand-held computer. In addition, although computer system 300 is illustrated, the systems and methods disclosed herein can be implemented in various alternative computer systems as well.

System 300 includes a processor unit 302, a system memory 304, and a system bus 306 that couples various system components including the system memory 304 to the processor unit 302. System memory includes read only memory (ROM) 308 and random access memory (RAM) 310. A basic input/output system 312 (BIOS), which contains basic routines that help transfer information between elements within computer system 300, is stored in ROM 308.

Computer system 300 further includes a hard disk drive 312 for reading from and writing to a hard disk, a magnetic disk drive 314 for reading from or writing to a removable magnetic disk 316, and an optical disk drive 318 for reading from or writing to a removable optical disk 319 such as a CD ROM, DVD, or other optical media. Hard disk drive 312, magnetic disk drive 314, and optical disk drive 318 are connected to the system bus 306 by a hard disk drive interface 320, a magnetic disk drive interface 322, and an optical drive interface 324, respectively. The drives and their associated computer-readable media provide nonvolatile storage of computer readable instructions, data structures, programs, and other data for computer system 300. Removable magnetic disk 316, and a removable optical disk 319, and other types of computer-readable media capable of storing data can also be used in the example system 300.

A number of program modules can be stored on hard disk 312, magnetic disk 316, optical disk 319, ROM 308, or RAM 310, including an operating system 326 such as the WINDOWS operating system from Microsoft Corporation, one or more application programs 328, other program modules 330, and program data 332.

A user can enter commands and information into computer system 300 through input devices such as, for example, a keyboard 334, mouse 336, or other pointing device. Examples of other input devices include a toolbar, menu, touch screen, microphone, joystick, game pad, pen, satellite dish, and scanner. These and other input devices are often connected to the processing unit 302 through a serial port interface 340 (or Universal Serial Bus (USB)—not shown) that is coupled to the system bus 306. A display 342 is also connected to the system bus 306 via an interface, such as a video adapter 344. In addition to the display 342, computer systems can typically include other peripheral output devices (not shown), such as speakers and printers.

Computer system 300 can operate in a networked environment using logical connections to one or more remote computers, such as a remote computer 346. The network connections include a local area network (LAN) 348 and a wide area network (WAN) 350. Such networking environments are commonplace in offices, enterprise-wide computer networks, intranets, and the Internet. When used in a LAN networking environment, the computer system 300 is connected to the local network 348 through a network interface or adapter 352. When used in a WAN networking environment, computer system 300 typically includes a modem 354 or other means for establishing communications over the wide area network 350, such as the Internet.

The embodiments described herein can be implemented as logical operations in a computing system. The logical operations can be implemented (1) as a sequence of computer implemented steps or program modules running on a computer system and (2) as interconnected logic or hardware modules running within the computing system. This implementation is a matter of choice dependent on the performance requirements of the specific computing system. Accordingly, the logical operations making up the embodiments described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the disclosure. This software, firmware, or similar sequence of computer instructions may be encoded and stored upon computer readable storage medium and may also be encoded within a carrier-wave signal for transmission between computing devices.

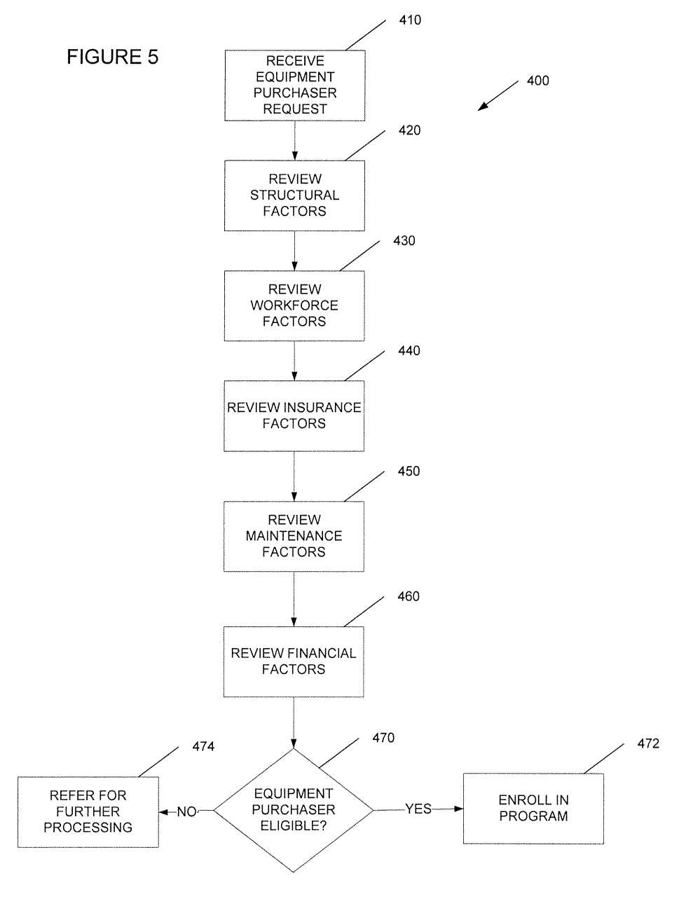

Referring now to FIG. 5, an example method 400 for qualifying an equipment purchaser for enrollment in program 112 is shown. At operation 410, the equipment provider receives a request from the equipment purchaser for enrollment in the program. This request includes information provided by the equipment purchaser in conjunction with making the request for enrollment. As described above, the request can be communicated in a variety of manners such as, for example, through the Internet, over the telephone, or through the email.

In example embodiments, the equipment provider advertises the existence of program 112 and encourages any equipment purchasers to request enrollment. In other embodiments, the equipment provider selectively invites equipment purchasers to enroll in program 112.

Next, at operation 420, the equipment provider reviews structural factors associated with the equipment purchaser. Examples of the factors include the number of years the equipment purchaser has been in the tree care industry and the number of employees. In example embodiments, the equipment provider sets minimums or maximum thresholds for these factors that determine eligibility for program 112. In the example shown, a minimum of 10 years, 5 years, or 1 year in the tree care industry is required for eligibility. In addition, a minimum of 50 employees, 25 employees, 10 employees, or 5 employees is required for eligibility. For example, in one embodiment, the equipment purchaser must have a minimum of five years in the industry and 6 employees to qualify for program 112.

Next, at operation 430, workforce factors associated with the equipment purchaser are reviewed. For example, the workforce factors include the processes that the equipment purchaser has in place to screen new employees and to provide training to existing employees. Examples of such training programs include new hire training, skills, productivity, safety, caliber, and OSHA standards. These workforce factors are analyzed to determine eligibility for program 112.

Next, at operation 440, insurance factors associated with the equipment purchaser are reviewed. In example embodiments, the insurance factors that are examined include, without limitation, the equipment purchaser's loss ratio and claims management plan. For example, in some embodiments, the equipment purchaser's loss ratio is examined over a specified period of time, such as 1 year, 2 years, 5 years, or 10 years, and the loss ratio is compared to a threshold, such as 25 percent, 40 percent, or 50 percent to determine eligibility. In the illustrated example, the loss ratio is examined for a 5 year period and the threshold is less than 50 percent. In some embodiments, the experience modification factor (sometimes referred to as the “experience modification rating”) is also examined to determine eligibility.

Next, at operation 450, service factors associated with the equipment of the equipment purchaser are reviewed. In example embodiments, the service factors that are examined include, without limitation, equipment conditions, equipment types, and equipment ages. Other service factors can also be addressed.

Next, at operation 460, financial factors associated with the equipment purchaser are reviewed. The financial factors that are examined can include, for example, the payroll history for the equipment purchaser relating to workman's compensation payments, and asset information related to qualifying for credit.

Finally, at operation 470, all of the factors that have been examined in operations 420, 430, 440, 450, 460 are analyzed to determine if the equipment purchaser is eligible for enrollment in program 112. The analysis can take a variety of forms. For example, in one embodiment, each of the factors examined in operations 420, 430, 440, 450, 460 is given a weighted score, and an average is calculated based on the scores. The average is compared to a threshold, and, if the average meets or exceeds the threshold, the equipment purchaser is determined to be qualified for enrollment in program 112.

If the equipment purchaser is determined to be eligible, control is passed to operation 472 and the enrollment process in program 112 is initiated. Alternatively, if the equipment purchaser is determined not to be eligible, control is passed to operation 474 and further processing is performed for the equipment purchaser. For example, in some embodiments, the disqualified equipment purchaser is notified and an explanation for the deficiencies is given. The disqualified equipment purchaser is then given a period of time to remedy these deficiencies and reapply for program 112. In some embodiments, the equipment provider facilitates the disqualified equipment purchaser with addressing the deficiencies. For example, if the disqualified equipment purchaser is deficient in the area of training for its employees, the equipment provider facilitates the provision of training to assist the disqualified equipment purchaser in addressing the deficiency.

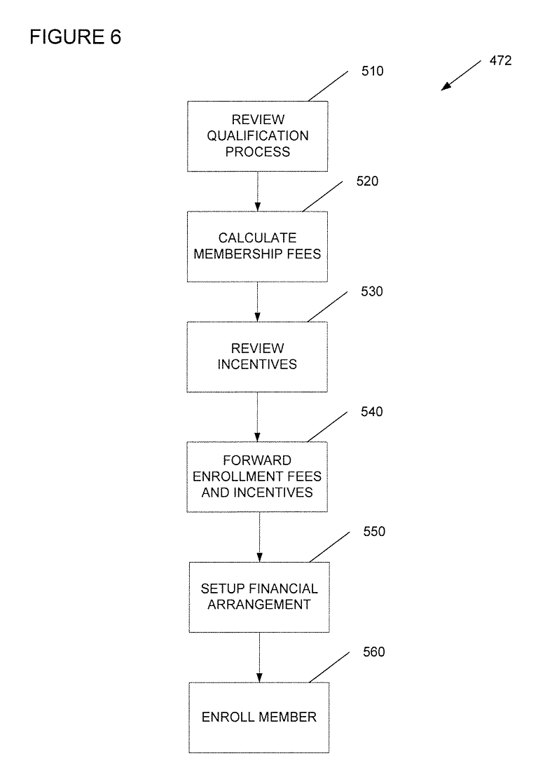

Referring now to FIG. 6, example enrollment operation 472 for a qualified equipment purchaser in program 112 is shown. At operation 510, the factors from operations 420, 430, 440, 450, 460 are again analyzed, and a membership fee is calculated at operation 520. One or more of the following example factors associated with the equipment purchaser can be used to calculate membership fees: number of pieces of equipment; number of employees; and geographic location. For example, the membership fees can be increased based on the number of pieces of equipment due to costs associated with the maintenance service, and the membership fees can also be increased based on the number of employees due to the costs associated with the insurance and workforce services. In alternative embodiments, other schemes can be used for calculating the membership fees, such as setting the membership fees as a percentage (e.g., 25 percent) of the estimated cost savings to the equipment purchaser.

Once the membership fee is calculated, control is passed to operation 530, and incentives for the equipment purchaser are reviewed. For example, in some embodiments, the equipment provider can provide an incentive service for the equipment purchaser as part of the program. In the illustrated embodiment, the incentive service is tied to the use of a credit card that is used both for payment of the membership fees and facilitation of the incentive service.

In the example shown, the incentive service includes a plurality of levels that are based on the total dollar amount of purchases of equipment by the equipment purchaser from the equipment provider, and tenure in the program. In one example, the levels are named Silver, Gold, and Platinum, in increasing order of incentives, although other configurations are possible. The equipment purchaser automatically qualifies for the Silver level, which provides a specific cash back bonus based on the volume of purchases made using the credit card. The cash back bonus can be used by the equipment purchaser to buy further equipment from the equipment provider. Silver level members also receive discounts for goods and services from other providers that are part of program 112. For example, discounted training can be provided from specified training providers for equipment purchasers that are members of program 112.

For the Gold level, the equipment purchaser must reach a specified level of purchasing of equipment from the equipment provider within a given period of time, or have tenure in program 112 for a specified period of time, such as 1 or 3 years. Gold level members receive a higher percentage of cash back, as well as the discounts for goods and services for other providers. For the Platinum level, the equipment purchaser must reach a specified level of purchasing of equipment from the equipment provider within a given period of time, or have tenure in program 112 for a specified period of time, such as 3 or 5 years. Platinum level members receive a higher percentage of cash back, as well as the discounts for goods and services for other providers.

Once the incentive service for the equipment purchaser is defined, control is passed to operation 540, and the membership fee and incentive service information is forwarded to the equipment purchaser for review and acceptance.

If the equipment purchaser decides to proceed with enrollment, control is passed to operation 550, and the financial arrangements for membership in program 112 are provided. In example embodiments, a credit card is issued to the equipment purchaser as part of the enrollment process. The credit card is an affinity card associated with the equipment provider. The affinity card is issued from a financial services provider, such as financial provider 250, and can be a typical credit card such as a MasterCard, VISA, or American Express card. The equipment purchaser may undergo the screening process provided by financial provider 250 to qualify for the credit card.

Equipment provider 210 and/or financial provider 250 manage the credit card and incentive service associated with use of the credit card. In example embodiments, the annual membership fee for program 112 is automatically charged to the credit card so that the risk associated with payment of the membership fee is shifted from the equipment provider to financial provider 250. In alternative embodiments, other forms of payment of the membership fee, such as other credit cards, cash, or check, can be used if, for example, the equipment purchaser does not qualify for the credit card associated with the program.

Once the financial arrangements have been made for membership, control is passed to operation 560, and the equipment purchaser is enrolled and becomes a member of program 112. Once a member, the equipment purchaser has access to the services and incentives associated with program 112, such as insurance service 120, workforce service 130, and maintenance service 140.

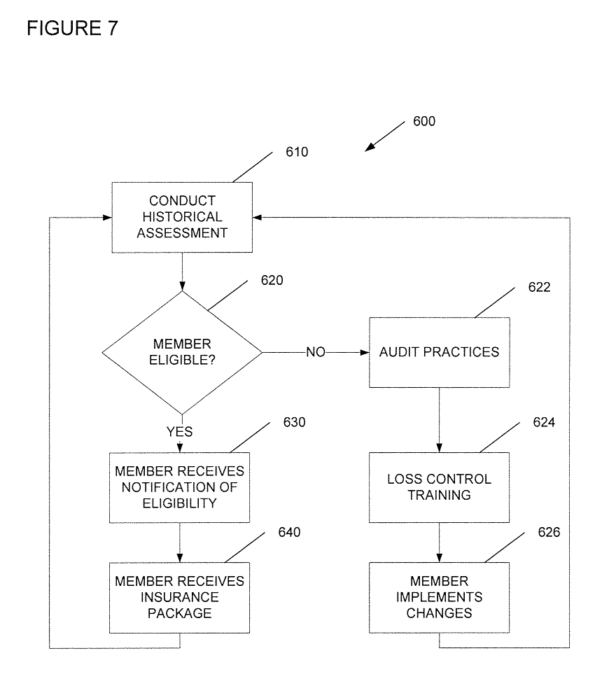

Referring now to FIG. 7, an example method 600 for implementing insurance service 120 is shown. Insurance service 120 generally involves an assessment of the member's historical loss record. Depending on the assessment, the member is offered an insurance package (e.g., worker's compensation and/or liability business insurance) with potentially favorable terms (e.g., lower premiums or return dividends) or is offered training to help the member to decrease losses. Equipment provider 110 negotiates with one or more insurance providers 210 to obtain an agreement with insurance provider 210 to offer potentially favorable insurance packages to those members of program 112 that are eligible, as described below.

In example embodiments, insurance service 120 is managed by equipment provider 110 in conjunction with insurance provider 210 and training provider 230. In addition, equipment dealers 240 can also assist in the assessment and insurance application process for members. In alternative embodiments, insurance service 120 can be managed exclusively by equipment provider 110, or exclusively by one or more insurance providers 210. For example, in one embodiment, the member initiates participation in insurance service 120 by contacting equipment provider 110 or equipment dealer 240, and the member is referred to insurance provider 210 for the audit and underwriting process, as described below.

Initially, at operation 610 of method 600, an audit is conducted of the member's historical losses. The audit includes an examination of the claims initiated by the member over a period of time, such as 1 year, 3 years, or 5 years. The audit can also include a review of the training that has historically been provided by the member to its workers. In one embodiment, the audit process includes a historic loss run and an on-site evaluation for safety according to guidelines promulgated by industry organizations such as the International Society of Arboriculture or the Tree Care Industry Association.

The results of the audit are analyzed, and a determination of whether or not the member is eligible after the audit is made at operation 620. For example, in one embodiment, the member is eligible if the member has less than a given threshold of claims within the specified period and the member has demonstrated that the attributes of an adequate safety and training program are in place.

If the member is eligible after the audit, control is passed to operation 630, and the member receives notification that it is eligible. Control is then passed to operation 640, and the member receives information on enrollment in an insurance package. The member can work with insurance provider 210 through the underwriting process and subsequently for service and claims processing. Control is then periodically (e.g., every 1 year, 2 years, or 5 years) passed back to operation 610 for re-audit of the member's losses and safety/training programs.

If the member is found not to be eligible after the audit process in operation 620, control is instead passed to operation 622, at which a more specific audit of the member's losses, programs, and practices is conducted to determine specific areas of weakness. Once again, this assessment can be conducted by either or both of equipment provider 110 and insurance provider 210. After this assessment is complete, loss control training is provided at operation 624. Training can be provided by either or both of equipment provider 110 and training provider 230.

In example embodiments, the content of the training is determined by insurance provider 210. In alternative embodiments, the loss control training is tailored to address those areas in which the member is determined to be lacking during the assessments at operations 610, 622. For example, if the audits show a disproportionate number of worker's compensation claims related to injuries associated with the operation of particular tree care equipment, the training program can be tailored to address this area. Likewise, if the audit shows a failure to conduct periodic (e.g., daily or weekly) safety onsite meetings, the training can be tailored to implementing such meetings.

Once the training has been completed, control is passed to operation 626, and the member implements the information that was provided during the training. Next, after a specified period of time, control is passed back to operation 610, and the audit process is conducted again. The goal of the process in operations 622, 624, 626 is to assist the member in improving losses so that the member can qualify for the potentially favorable insurance package from insurance provider 210.

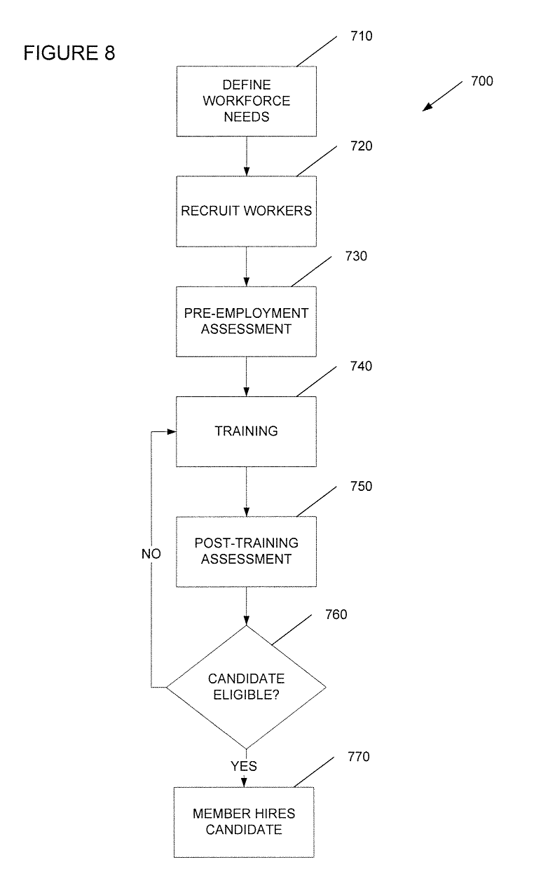

Referring now to FIG. 8, an example method 700 for implementing workforce service 130 is shown. Workforce service 130 generally includes an assessment of the member's recruitment needs, recruitment and tree care industry specific training of workers to fill those needs, and potential hiring of the workers by the member. In example embodiments, workforce service 130 is managed by equipment provider 110 in conjunction with workforce provider 220 and training provider 230. Equipment provider 110 assists in the initial assessment of the member's workforce needs, and workforce provider 220 assists in recruitment and training of workers, in conjunction with training provider 230.

Initially, at operation 710, the member's specific workforce needs for a given timeframe, such as 1 year, 2 years, or 5 years, are assessed. For example, annual turnover rates for workers in tree care industry 100 are approximated at 25 percent. In addition, tree care industry 100 is forecasted for growth. Therefore, the assessment at operation 710 takes into account turnover rates and projected growth for the member in determining workforce needs.

For example, if the member has a workforce of 4 workers, it is estimated that the member will need at least 1 worker as replacement for the loss of a worker in the upcoming year. In addition, if the member's growth is projected to be 25 percent for the upcoming year, it is estimated that the member will need another worker to handle growth of the member's business. Therefore, the assessment for the example would project a need of 2 workers for the member for the upcoming year.

Next, at operation 720, workers are recruited to fill the member's need. In the example shown, the recruitment is conducted by workforce provider 220. In example embodiments, workforce provider 220 can utilize recruiting tools specific to tree care industry 100, such as online sources (e.g., treecarejobs.com) or at locations or events specific to the tree care industry. Workforce provider 220 can also draw on non-industry specific sources for recruitment. For example, workforce provider 220 can draw on its existing base of workers or recruit from other sources, such as publications and referrals from the United States Department of Labor.

In example embodiments, needs and recruitment can be divided into specific pools, such as skilled and unskilled labor. Recruitment can also be divided based on the categories of workers that are needed such as, for example, ground workers, aerial lift operators, tree workers and climbing specialists, and arborists. Recruitment can also be divided into geographic regions of need.

Next, at operation 730, candidates identified by the recruitment process undergo a pre-employment assessment tailored to assess a candidate's skills as related to tree care industry 100. In example embodiments, this assessment can address both industrial as well as behavioral. In addition, the assessment can address typical employment-related issues, such as drug testing and background checks.

Next, at operation 740, the candidates undergo a training program that is specific to the tree care industry 100 and that can be tailored to the specific anticipated area of work for the candidates. In example embodiments, the training program is developed by one or more of equipment provider 110, training provider 230, and workforce provider 220. The training can be tailored to provide hands-on training for tree care industry 100 such as, for example, worksite awareness, equipment transportation, equipment operation (e.g., chainsaw, pole saw, stump cutter, brush chipper), ropes and rigging, and pruning. Other or different training can be provided.

In example embodiments, the candidates that undergo the training are compensated for their time during training. The compensation can come from various sources, including the U.S. Department of Labor in the form of government grants, and/or payment from equipment provider 110, workforce provider 220, and/or the member.

Next, at operation 750, the candidates undergo a post-training assessment to confirm if the candidates have learned the specified skills for a specific position or positions within the tree care industry 100. In example embodiments, the post-training assessment 750 includes a mixture of written and on-site assessments. Next, at operation 760, a determination is made as to whether or not each candidate is eligible after the assessment. If the candidate is eligible after the assessment, control is passed to operation 770 and the candidate is eligible to be hired by the member. In example embodiments, the worker can be hired on a permanent or temporary basis, as needed. In the example embodiment, the member can decide whether or not to hire the candidate. If, alternatively, the candidate is not eligible after the assessment, control is passed back to operation 740 so that the candidate can undergo further training.

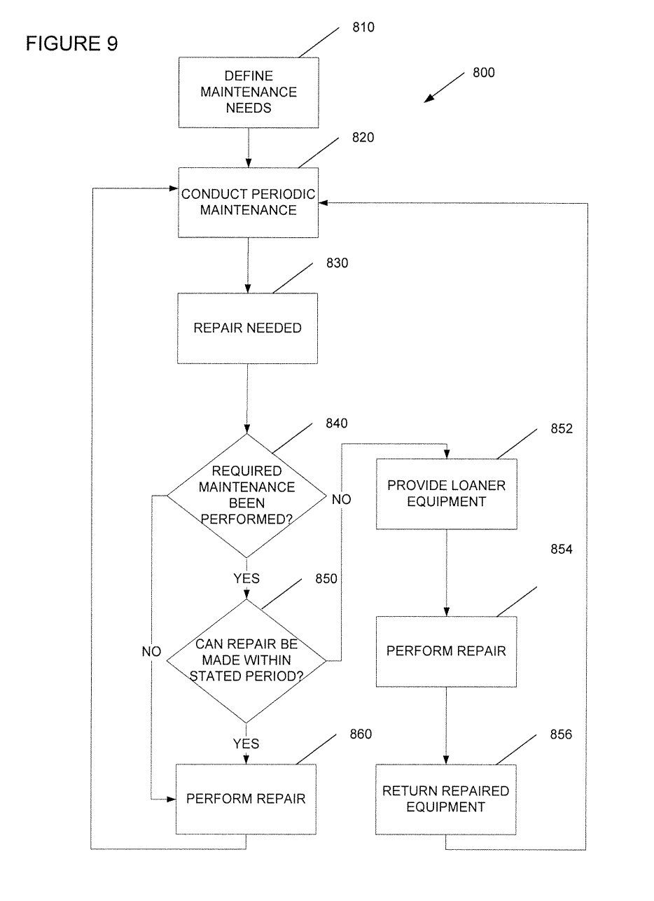

Referring now to FIG. 9, an example method 800 for implementing maintenance service 140 is shown. Maintenance service 140 generally includes service and repair components that maintain the member's equipment and help to minimize costs associated with downtime due to equipment failure through an equipment replacement or substitution program. Maintenance service 140 can be conducted on-site or at a central location. In example embodiments, equipment dealers 240 provide on-site service and repair for members.

Initially, at operation 810, the maintenance needs of the member are defined. This includes inventorying all equipment and identifying current service states. In example embodiments, maintenance service 240 can include equipment that was manufactured by equipment provider 110, as well as equipment that was manufactured by manufactures other than equipment provider 110. A maintenance template is created for each piece of equipment based on recommended service intervals for the equipment and/or the member's own preferred maintenance practices, if adequate.

Next, at operation 820, periodic maintenance is conducted for the equipment. In example embodiments, service must be performed at the required intervals and documented (e.g., electronically in an online database maintained by equipment provider 110, or in hard copy form using, for example, a decal on the equipment itself) for the member's equipment to qualify for the equipment replacement or substitution program, as described below. In one example, the service is provided on-site by equipment dealers 240. In another example, the member returns the equipment to a central location for service. In some embodiments, the member can perform self maintenance of its equipment if, for example, the member qualifies to perform the maintenance by undergoing specified training.

Next, at operation 830, a piece of equipment covered under maintenance service 140 fails and needs to be repaired. The member can contact equipment dealer 240 or equipment provider 110 to initiate such a repair. Next, at operation 840, a determination is made as to whether or not periodic maintenance has been provided for the equipment needing repair. If periodic maintenance has not been performed, control is passed to operation 860 and the repair is performed without the benefit of the replacement or substitution program.

Alternatively, if a determination at operation 840 is made that the required periodic maintenance for the equipment has been performed, control is passed to operation 850 and a determination is made regarding whether the repair can be made within a specified period of time as defined by the replacement or substitution program. In example embodiments, the specified period of time is 12 hours, 24 hours, 48 hours, or 1 week. If the repair can be made within this time period, control is passed to operation 860 and the repair is made.

Alternatively, if a determination at operation 850 is made that the repair cannot be made within the specified period of time (e.g., because a required replacement part cannot be easily located), control is passed to operation 852 and a loaner piece of equipment is provided for the member's use by equipment dealer 240 or equipment provider 110. In this manner, costs associated with downtime are minimized. Next, at operation 854, the repair is made while the member has the use of the loaner equipment. Finally, at operation 856, the repaired equipment is returned to the member.

In example embodiments, the costs associated with the repair are paid by equipment provider 110 if the failed equipment fails within a specified period of use, the failure is not due to negligence, abuse, accident, etc., and the member is otherwise in good standing wit the program (e.g., has paid dues, etc.). If the failed equipment falls outside the specified period of use, the member pays for the cost of repair. Other configurations, such as a shared cost approach, are possible.

In example embodiments, equipment provider 110 can provide incentives for equipment dealers 240 to maintain an inventory of equipment that can be used as loaner equipment for maintenance service 140.

In example embodiments, the equipment replacement or substitution program can be capped at a specified number of years for each machine. For example, in some embodiments, the equipment replacement or substitution program is provided for the first 5, 7, or 10 years of the life of a particular piece of equipment.

In some embodiments, if the member fails to provide the required periodic maintenance for the equipment prior to a failure, loaner equipment is provided on a graduated payment scale correlating to the degree of deviation from the service plan by the member. For example, if the member has generally maintained the service plan for the equipment but missed the most recent maintenance for the failed equipment, equipment can be provided in accordance with the equipment replacement or substitution program at a reduced cost to the member.

In some embodiments, equipment provider 110 and/or equipment dealers 240 implement a service management package that automatically tracks service hours for equipment and notifies the member when service is due. The service management package can include automatic scheduling of service appointments and/or automatic shipping of service items for those members that perform self-maintenance.

Alternative embodiments to those described herein are possible. For example, although the examples provided above are described in relation to the tree care industry, in alternative embodiments the concepts associated with program 112 can be extended to other industries. For example, the program can be instituted in industries such as the landscape industry, utility installation industry, agricultural industry, horizontal directional drilling industry, and/or open trenching industry. Other industries are possible.

In addition, other or different services beyond the insurance, workforce, and maintenance services can be offered as part of the program. For example, in one alternative embodiment, a lean contractor service can be provided. The lean contractor service provides on-site analysis of the equipment purchaser's working environment to identify wasteful practices in the office, shop, and/or jobsite, as well as recommendations on how to minimize such wasteful practices to improve efficiency. In another example, a procurement service can be provided. The procurement service provides an industry-specific store from which the equipment purchaser can make purchases. In examples, the store can be an online or hard copy catalog that includes equipment and services specific to the given industry.

The various embodiments described above are provided by way of illustration only and should not be construed to be limiting. Those skilled in the art will readily recognize various modifications and changes that may be made to the embodiments described above without departing from the true spirit and scope of the disclosure or the following claims.

What is claimed is:

1. A method for an equipment manufacturer to form a program with an equipment purchaser, the method comprising:
enrolling the equipment purchaser in the program;
facilitating an insurance package for the equipment purchaser;
facilitating recruitment, training, and hiring of workers to meet the workforce needs of the equipment purchaser;
having service needs of the equipment purchaser assessed;
facilitating periodic service for the equipment purchaser's equipment; and
facilitating replacement or substitution if the equipment fails.

2. The method of claim 1, further comprising establishing a relationship with an insurance provider to offer the insurance package.

3. The method of claim 1, further comprising establishing a relationship with a workforce provider to recruit, train, and hire the workers.

4. The method of claim 1, further comprising establishing a relationship with a training provider to train the workers.

5. The method of claim 1, further comprising providing incentives for the equipment purchaser to enroll in the program.

6. The method of claim 1, wherein facilitating replacement or substitution further comprises establishing a relationship with a local service provider to review the failed equipment, provide loaner equipment for the equipment purchaser if the failed equipment cannot be fixed within a specified period of time, and repair the failed equipment.

7. A method for forming a program with a tree care equipment manufacturer and an equipment purchaser, the method comprising:
enrolling the equipment purchaser if the equipment purchaser qualifies for the program;
providing an insurance package for the equipment purchaser;
recruiting, training, and placing workers to meet the workforce needs of the equipment purchaser;
assessing service needs of the equipment purchaser;
providing periodic service for the equipment purchaser's equipment; and
providing replacement or substitution if the equipment fails.

8. The method of claim 7, further comprising providing incentives for the equipment purchaser to enroll in the program.

9. The method of claim 7, wherein providing replacement or substitution further comprises:
reviewing the failed equipment;
providing loaner equipment for the equipment purchaser if the failed equipment cannot be fixed within a specified period of time; and
repairing the failed equipment.

10. The method of claim 9, wherein providing loaner equipment further comprises providing the loaner equipment only if the failed equipment has been serviced according to a service plan.

11. The method of claim 9, wherein providing loaner equipment further comprises providing the loaner equipment according to a graduated payment scale correlating to a degree of deviation by the equipment purchaser from the service plan.

12. A system for forming a program with an equipment provider and an equipment purchaser, the system comprising:
an insurance service including an insurance package that is provided for the equipment purchaser;
a workforce service including recruitment and training of workers for the equipment purchaser; and
a maintenance service including periodic servicing of the equipment purchaser's equipment, and, upon failure of the equipment, loaner equipment for the equipment purchaser if repairs to the failed equipment cannot be made in a specified period of time.

13. The system of claim 12, wherein the equipment provider is a manufacturer of tree care equipment.

14. The system of claim 12, wherein the equipment purchaser is a provider of tree care services.

15. The system of claim 12, wherein the equipment provider manufactures tree care equipment, and the equipment purchaser purchases the tree care equipment from the equipment provider.

16. The system of claim 12, wherein the equipment provider establishes a relationship with an insurance provider to facilitate the insurance service.

17. The system of claim 12, wherein the equipment provider establishes a relationship with a workforce provider to facilitate the workforce service.

18. The system of claim 12, wherein the equipment provider establishes a relationship with a training provider to provide training services to facilitate the insurance service and the workforce service.

19. The system of claim 12, further comprising an enrollment program including an assessment of the equipment purchaser's qualifications for enrollment in the program.
